(19) United States
(12) Patent Application Publication
(10) Pub. No.: US 2012/0262536 A1
(43) Pub. Date: Oct. 18, 2012

(54) STEREOPHONIC TELECONFERENCING USING A MICROPHONE ARRAY

(75) Inventors: Wei-ge Chen, Sammamish, WA (US); Zhengyou Zhang, Bellevue, WA (US)

(73) Assignee: Microsoft Corporation, Redmond, WA (US)

(21) Appl. No.: 13/086,632

(22) Filed: Apr. 14, 2011

(51) Int. Cl. H04N 7/14; H04R 5/02; H04R 5/00

(52) U.S. Cl. 348/14.08; 381/26; 381/309; 381/17; 348/E07.083

(57) ABSTRACT

Stereophonic teleconferencing system embodiments are described which advantageously employ a microphone array at a remote conference site having multiple conferencees to produce a separate output channel from the each microphone in the array. Audio data streams each representing one of the audio output channels from the microphone array are then sent to a local conference site where a local conferencee is in attendance. The voices of the aforementioned remote conferencees are spatialized within a sound-field of the local site using multiple loudspeakers. Generally, this involves receiving the monophonic audio data streams from the remote site, and processing them to generate an audio signal for each loudspeaker. Each of the generated audio signals is then played through its respective loudspeaker to produce a spatial audio sound-field which is audibly perceived by the local conferencee as having the voice of each of the remote conferencees coming from a different location.

### BACKGROUND

Stereophonic teleconferencing between two geographically remote sites is achieved where signals from stereo microphones at one site are played on an equal number of loudspeakers at the other site. Such a setup has enabled the use of spatial audio to enhance the user experience. In these spatial audio schemes, the voice of each conferencee captured at a first site is mapped to a distinct virtual location in the sound-field of the other site. Spatialized audio has been shown as an effective mechanism to help the listener resolve and understand the conversations with less cognitive load.

Currently, to achieve a fully spatialized audio effect where each participant's voice is mapped to a different virtual location, each participant has to have his or her own microphone. While a party participating from an individual office typically has a dedicated microphone, a group of co-located participants gathered together for a teleconference (e.g., in a meeting room) typically share a common voice input device. In such a situation, the voices of all the co-located conferencees are spatialized to a common virtual location.

### SUMMARY

The stereophonic teleconferencing system embodiments described herein advantageously employ a microphone array at a remote conference site having multiple conferencees to produce a separate output channel from the each microphone in the array. This in effect forms a collection of spatial samples of the sound-field in the remote site. Audio data streams representing the audio output channels from the microphone array at a remote site are then sent to a local conference site where a local conferencee resides. The voices of the aforementioned remote conferencees are spatialized within a sound-field of the local site using multiple loudspeakers and a computing device. In one implementation, the local site sound-field is defined as an angular presentation region sweeping outwardly from the local conferencee's face. Generally, the computing device executes a computer program having program modules, which first receive monophonic audio data streams from the remote site over the computer network. Each of these monophonic audio data streams corresponds to the output of a different microphone in a microphone array resident at the remote site. A program module then processes the monophonic audio data streams to generate an audio signal for each loudspeaker, and plays each of the generated audio signals through its respective loudspeaker to produce a spatial audio sound-field which is audibly perceived by the local conferencee as having the voice of each of the remote conferencees coming from a different location. Thus, the stereophonic teleconferencing system embodiments described herein has an advantage in that the voices of each conferencee at a remote site are separately spatialized using a single microphone array.

The stereophonic teleconferencing system embodiments described herein can also spatialize audio for a local conferencee at a local site who is participating in a teleconference with two or more sites each of which is remote from the local site and at least one of which has a plurality of co-situated conferencees. Generally, this multiple remote site scenario is handled by splitting up the local site angular space into as many sectors as there are remote sites participating in the teleconference. The voices of the conferencees at a remote site having multiple conferencee in attendance are then spatialized within a sector of the local site angular space assigned to that remote site.

It should also be noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is an exemplary architectural diagram of a computer network environment for providing a stereophonic teleconference.

FIG. 2 is a diagram depicting an exemplary setup for a remote site having multiple conferencees participating in a stereophonic teleconference.

FIG. 3 is a diagram depicting an exemplary setup for a local site having a single conferencee participating in a stereophonic teleconference with a remote site having multiple conferencees in attendance.

FIG. 4 is a diagram depicting an exemplary setup for a local site having a single conferencee participating in the stereophonic teleconference with multiple remote sites each having multiple conferencees in attendance.

FIG. 5 is a diagram depicting an exemplary setup for a local site having a single conferencee participating in the stereophonic teleconference with multiple remote sites, one of which has multiple conferencees in attendance and one of which has a single conferencee in attendance.

FIG. 6 is a diagram depicting a general purpose computing device constituting an exemplary system for implementing stereophonic teleconferencing system embodiments described herein.

### DETAILED DESCRIPTION

In the following description of stereophonic teleconferencing system embodiments reference is made to the accompanying drawings which form a part hereof, and in which are shown, by way of illustration, specific embodiments in which the system may be realized. It is understood that other embodiments may be utilized and structural changes may be made without departing from the scope of the system.

### 1.0 Stereophonic Teleconferencing Using a Microphone Array

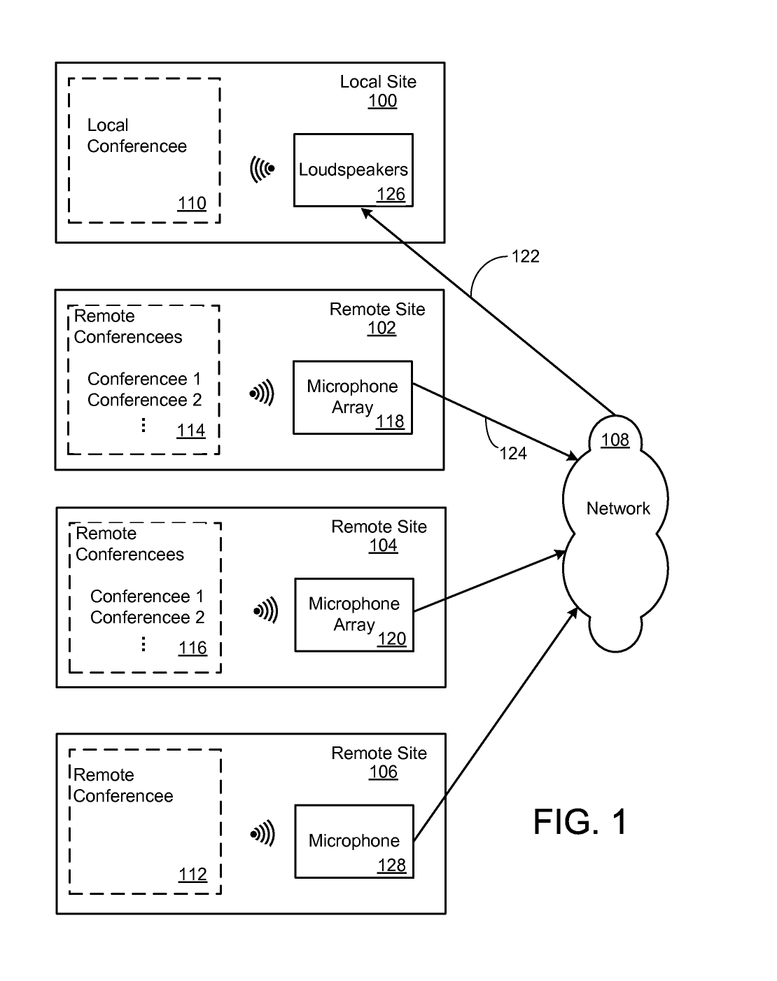

FIG. 1 illustrates a diagram of an exemplary embodiment, in simplified form, of a general architecture of a system for providing a stereophonic teleconference. FIG. 1 illustrates four different sites 100/102/104/106 participating in an audio teleconference where the venues are remote from one another and interconnected by a computer network 108. It is noted that four sites are shown for exemplary purposes only, as the actual number of sites participating can be as little as two or three and can exceed four. At some sites (e.g., sites 102/104 shown in FIG. 1) multiple (i.e., two or more) co-situated conferencees 114/116 participate in the audio teleconference, while at other sites (e.g., 100/106 shown in FIG. 1) a single conferencee 110/112 participates. In general, the audio (and video in many cases) captured at each site is provided to the other sites during the teleconference. However, it is the generation of audio from remote sites (such as for example sites 102/104/106 in FIG. 1), and the processing of these audio feeds at a local site typically having a single conferencee (such as site 100 in FIG. 1), that are key to understanding the present stereophonic teleconference system. As such the following description will focus on this scenario, although it is noted that the present system can also be used at the remote sites as well in which case the remote site would take on the role of the local site in the context of the following description.

Consider a local conferencee 110 who wishes to participate in a teleconference from a local site 100 with other remote conferencees that are not at the local site. Also, consider a remote site (such as site 102 in FIG. 1) in which a group of two or more remote conferencees 114 have gathered for a teleconference. In general, spatial samples of the sound-field at the remote site 102 are captured and sent to the local site 100 via the network 108, where they are warped and played over loudspeakers 126 to produce a virtual sound-field that sounds to the local conferencee 110 as if he or she was situated at a conference table with remote conferencees 114.

Note that other remote conferencees (such as remote conferencees 112/116 in FIG. 1) from other remote sites (such as sites 104/106 in FIG. 1) can be integrated into the teleconference as well. The addition of other remote sites will be described in more detail later in this description.

Generally, the stereophonic teleconferencing system embodiments described herein advantageously employ a microphone array (such as arrays 118/120 in FIG. 1) at remote sites having multiple conferencees. However, instead of operating the microphone array in a typical manner where spatial filtering is used to produce a single output channel from the signals produced by the multiple microphones in the array, a separate output channel is produced from the each microphone in the array. This in effect forms a collection of spatial samples of the sound-field in the remote site. Audio data streams (such as 122/124 in FIG. 1) representing the audio output channels from the microphone array at a remote site are sent to the local site.

It is noted that bypassing the spatial filtering typically employed in a microphone array can introduce noise in the aforementioned samples. However, this is not an issue as the human auditory system can choose to focus on certain elements of the spatial sound-field and ignore the undesired (e.g., noise) elements. In addition, since spatial filtering is in effect accomplished with the listener's own ears, the system embodiments described herein do not need to perform sound source localization, and hence are not prone to localization errors and will not falsely attenuate any remote speaker. Further, the system embodiments described herein adeptly handle situations where multiple local participants are speaking simultaneously as will be evident from the following description.

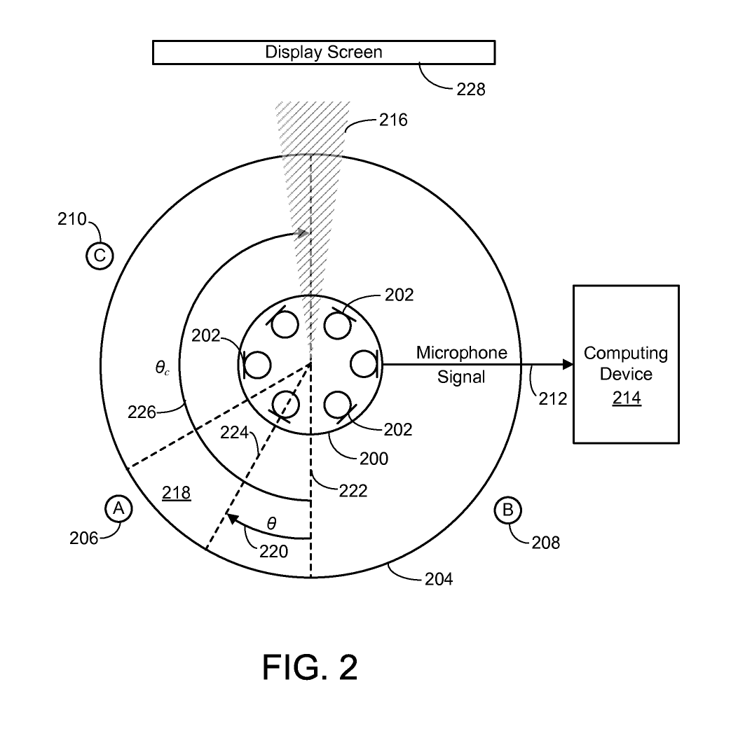

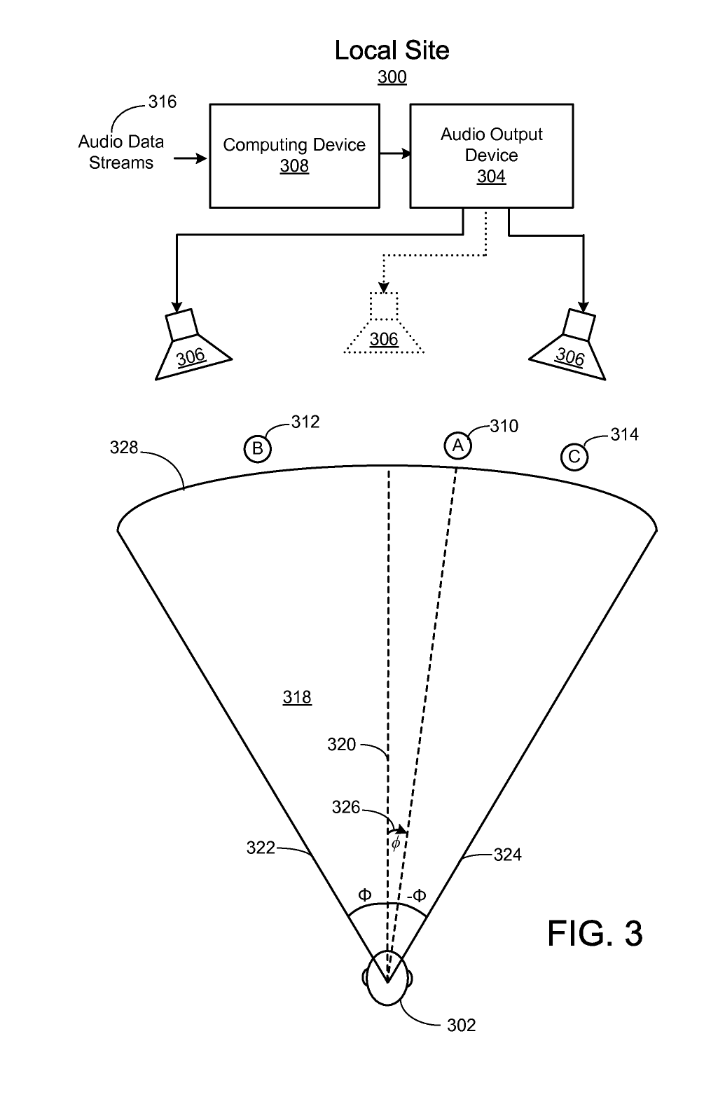

FIGS. 2 and 3 respectively depict a more detailed view of an exemplary setup for a remote site having multiple conferencees and a local site having a single conferencee. FIG. 2 shows a microphone array 200, which in this example is a circular microphone array having six equally spaced microphones 202, placed in the center of a conference table 204. Local participants A 206, B 208 and C 210 are positioned around the table 204. In the example shown in FIG. 2, the table 204 is round. However, it can be seen that other shapes are equally viable, such as a square or rectangular table with participants A and C on one side, and B on the other. As indicated previously, all the channels of the microphone signal are retained and considered as (in the case of a directional circular array) angular samples of the sound-field in the remote site. The microphone signal 212 is feed into a computing device 214 which processes it and sends audio data to the local site via the network. More particularly, the computing device 214 executes a computer program having program modules, which send monophonic audio data streams derived from the microphone signal from the remote site to the local site over the computer network. Each of the monophonic audio data streams corresponds to the output of a different microphone in the microphone array.

FIG. 3 shows an exemplary configuration of a local site 300, where the voices of the aforementioned remote conferencees A 310, B 312 and C 314 appear in prescribed virtual positions. Note that the prescribed virtual positions of the remote conferencees at the exemplary remote site of FIG. 3 reflect the same general direction (although not necessarily the true direction) each would be in relation to the local conferencee 302 should he or she be sitting near the edge of the table 204 in the shaded are 216 of FIG. 2. It is believed the local conferencee will have a more realistic experience if he or she feels like they are sitting at (or at least near) the edge of the conference table. However, this is not a limitation of the system. The voices of the remote conferencees could be virtually located in any order and at any angle from the local conferencee. The voices of the aforementioned remote conferencees are spatialized in the foregoing manner with the use an audio output device 304 having multiple loudspeakers 306, and a computing device 308. The computing device 308 is in communication with the aforementioned network so that it can receive the audio data from the remote site, and outputs signals to the audio output device 304. More particularly, the computing device 308 executes a computer program having program modules, which first receive the monophonic audio data streams from the remote site over the computer network, and then process the data streams to generate an audio signal for each loudspeaker 306 of the audio output device 304. The computing device 308 then plays each of the generated audio signal via the audio output device 304 and loudspeakers 306 to produce a spatial audio sound-field which is audibly perceived by the local conferencee 300 as having the voice of each of the remote conferencees 310/312/314 coming from a different location within the sound-field.

In the following sections, embodiments of the stereophonic teleconferencing system employing different kinds of microphone arrays will be described. In particular, these arrays include directional circular microphone arrays, omni-directional circular microphone arrays and linear microphone arrays. In addition, different configurations for the audio output device and loudspeakers will be described.

### 1.1 Stereophonic Teleconferencing Using a Directional Circular Array

Circular arrays have the advantage of better front to back resolution and can be placed in the middle of a room. In general, a directional circular microphone array placed in the middle of a remote site with multiple conferencees (such as in the middle of a conference table) so that it is somewhat surrounded by the conferencees can be said to have microphones that each capture sound from sources located in an angular sector facing outwardly from a prescribed center point of the array. Thus, each of the aforementioned monophonic audio data streams represents sounds captured in a different one of the angular sectors. As can be seen in FIG. 2, each angular sector 218 is assigned a capture angle 220 representing an angle from a prescribed arbitrary zero angle line 222 to a line 224 bisecting the angular sector. The capture angle 220 associated with each angular sector 218 is sent from the remote site to the local site over the computer network.

The remote site receives the monophonic audio data streams and capture angles, and processes them by first defining a local conferencee sound-field. As shown in FIG. 3, this local sound-field is an angular presentation region 318 sweeping outwardly from the local conferencee's face. In general, for each received monophonic audio data stream 316, the capture angle assigned to the angular sector associated with the stream is mapped to a different presentation angle φ 326 within the local conferencee's angular presentation region 318. An audio signal is then generated for each loudspeaker from the received monophonic audio data stream using conventional spatial audio methods such that when the signal is played, a spatial audio sound-field is produced that is audibly perceived by the local conferencee as having the voice of each of the remote conferencees coming from a different location within local conferencee's angular presentation region 318.

In one implementation shown in FIG. 3, the angular presentation region 318 is bisected by a zero presentation angle line 320, bounded to the right of the zero presentation angle line by a maximum positive presentation angle Φ 322 and on the left of the zero presentation angle line by a maximum negative presentation angle −Φ 324. In such an implementation, the aforementioned mapping involves mapping capture angles less than a prescribed cutting angle (e.g., θ_{c} 226 in FIG. 2) to a portion of the angular presentation region 318 to the left of the zero presentation angle line 320 and capture angles exceeding the prescribed cutting angle to a portion of the angular presentation region to the right of the zero presentation angle line.

For example, given the foregoing configuration of a remote site with multiple conferencees and a local site with a local conferencee, suppose there are N microphones (e.g., six in the example of FIG. 2) in the circular array located at the remote site. Assuming the microphones in the array are directional, the captured sound sample sᵢ(t), iε[0,N−1] from the microphone at an angle θᵢ is placed at a virtual position φⱼ where jε[0, N−1] relative to the listener. Virtualized samples from all of the microphones are summed up and hence produce a surround sound effect which covers the entire auditory space. In one implementation, the goal is to present the user with a sound-field that covers all the angles coherently and is situated in front of him or her. As such, it suffices to set up a straightforward mapping between the capture angles θ and presentation angles φ in the following manner:

$$φ ( θ ) = \frac{Φ}{π} ( θ - {θ}_{c} ) - Φ \qquad ( 1 )$$

where θ_{c} is the aforementioned cutting angle, θε[θ_{c}, θ_{c}+2π], φε[−Φ, Φ].

Generally, what is being accomplished is “cutting” a 360 degree surround sound-field open at θ_{c} and “warping” it to angles between −Φ and Φ. The choice of Φ is rather arbitrary and can depend on user preference. In general, given the configurations of FIGS. 2 and 3, Φ can range from 0 to 90 degrees and −Φ can range from 0 to −90 degrees. This ensures that the voices of all the remote site conferencees seem to be as coming from location in front of the local conferencee. However, as will be discussed later, there is a scenario where the Φ can range beyond 90 degrees up to 180 degrees and −Φ can range beyond −90 degrees up to −180 degrees. In another implementation where the visual scene of the remote site is displayed at the local site, the directions of the virtual sound sources are aligned with that of the visual display. For example, a large curved display (such as 328 in FIG. 3) can be employed at the local site. In such a case, the angle Φ shall be jointly determined by the size of the screen and the location of the local site conferencee.

### 1.1.1 Cutting Angle Selection

In one implementation, θ_{c} is determined such that after the warping, the pairwise relationships between the captured channels are preserved in the presentation space. This is not an issue except for between φ₀ and φ_{N-1}, where the spatial perception could be distorted as two adjacent spatial samples are presented far apart. To minimize this effect, θ_{c} is placed in between a microphone pair that is most unlikely to contain a source. Since if a source is situated in between a microphone pair, the two microphone signals will be highly correlated, θ_{c} can be chosen as the angle that falls between two adjacent microphones that have the least normalized correlation in their signals, i.e.,

θ_{c}=(θₗ+θₘ)/2 (2)

l=argminᵢr(i,k) (3)

r(i,k)=max_{τ}Σₜsᵢ(t)sₖ(t+τ)/(∥sᵢ(t)∥∥sₖ(t+τ)∥) (4)

where i=[0,N−1], k=i+1 mod N, m=l+1 mod N and t and τ are valid time indexes to sound samples collected during a training period. Initially, Φ=0 (equivalent to traditional mono audio conference) and Φ is slowly enlarged after θ_{c} has been determined.

In the case of a video conference, θ_{c} can be determined by simply using a visual cutting procedure to guarantee no local participant is located near the cutting position. In one implementation, this entails receiving a video feed from the remote site over the computer network, and choosing the cutting angle such that a substantially horizontal line projecting out from the center point of the remote site's microphone array at the chosen angle comes no closer than a prescribed offset distance from any of the remote site's plurality of co-situated conferencees as determined using the video feed from the remote site.

In another implementation, where the remote site has a display screen (228 in FIG. 2), θ_{c} can be directed toward the screen (as shown in FIG. 2) as it is less likely any of the remote site conferencees would sit at the end of the table in front of the screen. In one implementation, this entails receiving a video feed from the remote site over the computer network that reveals the remote site has a display screen. The cutting angle is then chosen such that a horizontal line projecting out from the center point of the remote site's microphone array at the chosen angle is directed perpendicular to the display screen using the video feed from the remote site.

In yet another implementation, θ_{c} can be set arbitrarily, and Φ can be set to be very large (e.g., close to π), thus practically eliminating any warping distortion.

### 1.1.2 Simulating Remote Conferencee Motion

It is also possible to add motion to a conferencee whose voice is spatially positioned at the local site. In general, this can be done by varying the capture angle θ in Eq. (1). More particularly, the previously-described mapping scheme can be modified by periodically varying the capture angle assigned to the angular sector (or sectors) associated with one or more of the monophonic audio data streams (i.e., the streams that include the audio data associated with the remote site conferencee that is desired to virtually put into motion). Each time the capture angle is varied, it is re-mapped to a different presentation angle within the local conferencee's angular presentation region so as to make it seem to the local site conferencee that the remote conferencee voice is moving.

In one implementation where the speaker is not actually moving in the remote site, the capture angle θ in Eq. (1) is randomly, but smoothly varied over time, or varied in a way to simulate natural head motion, for an increased immersive experience. If the speaker is actually moving in the remote site, in one implementation, the speaker can be visually tracked using conventional methods, and the capture angle θ in Eq. (1) can be varied to match the speaker's movements.

### 1.2 Stereophonic Teleconferencing Using a Non-Directional Microphone Array

In general, omni-directional circular microphone arrays and linear microphone arrays can be employed by first simulating the signals that would be produced by each array microphone had the array been a directional circular array. This is accomplished by simultaneously employing an appropriate beamforming technique on each of the signals output from the array microphones. Once the signals are simulated, the procedures described above can be employed to create the desired spatialized audio environment at the local site. The following sections provide a more detailed description of the signal simulation.

### 1.2.1 Stereophonic Teleconferencing Using an Omni-Directional Circular Array

With circular omni-directional arrays, it is possible to employ a beamformer to create a virtual circular directional microphone array. Beamforming is a spatial filtering technique used in microphone arrays for directional signal capture. It combines signals captured by individual microphones in the array in such a way that signals coming at a particular angle produce strong responses and while others are attenuated. The key is to determine the appropriate weighting coefficients for individual microphones. There are existing beamforming techniques that are capable of transforming the output from a circular omni-directional array to mimic the output from a circular directional microphone array. Any of these existing techniques can be employed with the stereophonic teleconferencing system embodiments described herein for this purpose.

### 1.2.2 Stereophonic Teleconferencing Using a Linear Array

Linear microphone arrays do not provide an angular sampling of the sound-field. Instead, the looking directions for each microphone are parallel to each other and their pickup patterns are quite broad. To simulate the signal that would have been obtained from a directional circular array, virtual looking directions can be created that correspond to the angular sampling of the circular array using an appropriate beamformer. The configuration of the beamformer is facilitated by noting the following factors.

The number of beams that are sufficient for perception of the local surround sound-field is equivalent to N in the case of the circular array. Since N is not very large, the beam patterns don't need to be very narrow. Secondly, unlike in the conventional use of a microphone array, no sound source localization is performed. Beamforming is conducted in N directions simultaneously. The output of each beam will be virtualized and summed together again. Hence it is desirable that each beam complements its neighbors so that no section of the local sound-field is attenuated. Thirdly, the spatial filtering capability of the human auditory system can be relied upon remove noise. Accordingly, signal and noise statistics are not needed.

There are existing beamforming techniques that are capable of transforming the output from a linear microphone array to mimic the output from a circular directional microphone array. Any of these existing techniques can be employed with the stereophonic teleconferencing system embodiments described herein for this purpose.

### 1.3 Local Site Playback

As indicated previously, an audio signal is generated for each loudspeaker in the local site from the received monophonic audio data streams using conventional spatial audio methods such that when the signal is played a spatial audio sound-field is produced that is audibly perceived by the local conferencee as having the voice of each of the remote conferencees coming from a different location within local conferencee's angular presentation region. In one implementation, the loudspeakers are multiple stand-alone loudspeakers. In another implementation, the loudspeakers that the form of stereo headphones or earphones.

### 1.3.1 Playback Using Stand-Alone Loudspeakers

Once the capture angle θ to presentation angle φ mapping is determined, the desired audio spatialization can be achieved. In the case where stand-alone loudspeakers are resident at the local site and are going to be used to effect the audio spatialization, this generally involves mapping each monophonic signal sᵢ(t) to a virtual angle φ(θᵢ) over stereo loudspeakers. Conventional procedures are employed for the audio virtualization, although a tunable delay adjustment can be included for additional effect. In general, a first of a set of stand-alone loudspeakers is positioned in the local site so as to generally face the local conferencee from a location corresponding to a first outer edge of the angular presentation region, and a second of the set of stand-alone loudspeakers is positioned in the local site so as to generally face the local conferencee from a location corresponding to a second outer edge of the angular presentation region. Additional stand-alone loudspeakers (if any) are positioned in the local site so as to generally face the local conferencee from a location between the first and second outer edges of the angular presentation region.

The exact steps taken depend on the loudspeaker setup at the local site. For instance, consider the following two examples—one involving a 3 loudspeakers implementation and the other involving a 2 loudspeakers implementation.

### 1.3.1.1 Virtual Sound Source Positioning Using 3 Loudspeakers

Assume the right loudspeaker is positioned in relation to the local site conferencee at the angle Φ, the left loudspeaker is positioned at the angle −Φ and the center loudspeaker is positioned at angle zero. A virtual source is to be positioned at the angle φ(θᵢ). The delay and gain for each loudspeaker is calculated as if the sound were captured by a corresponding hyper-cardioid microphone, which has, to the first order approximation, a directional pattern described by g(ψ)=α+(1−α)cos(βψ). Based on the above, the left (l), center (c) and right (r) loudspeaker signals are created by applying appropriate gain and delay to each microphone signal sᵢ(t) and summing them up as follows:

rₗ(t)=Σᵢg(Φ+φ(θᵢ))sᵢ(t+d(Φ+φ(θᵢ))) (5)

r_{c}(t)=Σᵢg(φ(θᵢ))sᵢ(t+d(φ(θᵢ))) (6)

rᵣ(t)=Σᵢg(Φ−φ(θᵢ))sᵢ(t+d(Φ−φ(θᵢ))) (7)

where i=[0, N−1], d(ψ)=D−D cos(γψ) and D is an adjustable constant which in one implementation was set to 0.45 milliseconds, representing half of the interaural time difference. Another constant α is determined as follows. When the virtual sound is positioned at the right loudspeaker, sound from the left loudspeaker is not expect, and vice versa. Thus, α is solved from g(2*Φ)=0. For example, when Φ=2π/5 (72°), α=0.4472. β and γ are tunable constants that are adjusted according to the subjective listening preference of the local conferencee. For the case of three loudspeakers, it has been found that setting β=1 and γ=1 produce satisfactory results, although an individual local conferencee may desire different settings.

It is noted that the foregoing procedure can be easily extended to more than three loudspeakers.

Finally, it is noted that playing spatialized audio at the remote site can pose an acoustic echo cancellation issue. However, there are existing acoustic echo cancellation techniques that are capable of resolving this issue. Any of these existing techniques can be employed with the stereophonic teleconferencing system embodiments described herein for this purpose.

### 1.3.1.2 Virtual Sound Source Positioning Using 2 Loudspeakers

Again, assume the right loudspeaker is positioned at the angle Φ and the left loudspeaker is positioned at the angle −Φ. The left and right loudspeaker signals are created using the previously described Eqs. (5) and (7), respectively, except that it has been found that setting α=0, β=θ/4Φ and γ=π/2Φ produces satisfactory results in the two loudspeaker case. Although, as before, an individual local conferencee may prefer different settings.

### 1.3.2 Playback Using Headphones or Earphones

In many situations, the local conferencee wears headphones or earphones, which in general are a pair of integrated stereo loudspeakers which are disposed onto or in the ears of the local conferencee. In cases where headphones or earphones are going to be used to effect the audio spatialization, it is possible to use the procedures described above in connection with the two stand-alone loudspeaker scenario where the left and right earpieces would equate to the left and right stand-alone loudspeakers. However, with headphones or earphones, the audio signals are being played back directly into the ear canals. Given this it possible to provide a more realistic experience if the signals are processed to simulate the diffraction and reflection properties of the pinna (or auricle), head and body of the local conferencee. Thus, to virtualize audio to the desired angle φ(θᵢ), it is possible to take advantage of the well known head related transfer functions. These functions are the measured responses of an impulse emitted from any external point in space to the left and right ears. Thus, in one implementation, the left and right signals are:

rₗ(t)=Σᵢ₌₀^{N-1}sᵢ(t)*hₗ(t; φ(θᵢ)) (8)

rᵣ(t)=Σᵢ₌₀^{N-1}sᵢ(t)*hᵣ(t; φ(θᵢ)) (9)

where sᵢ(t) is the input signal from microphone channel i; hₗ(t; φ(θᵢ)) and hᵣ(t; φ(θᵢ)) are the head related impulse responses (HRIR) for the left and right ears respectfully. The elevation angle is set to zero and any standard or measured set of HRIRs can be employed.

### 1.3.2.1 Virtual Steering

It is noted that when a remote participant is wearing headphones, he or she may turn their head during the teleconference. Using the foregoing procedure would result in it seeming to the local conferencee that the currently-speaking remote conferencees are moving in unison with their head movement. While this scenario might be acceptable, in one implementation virtual steering actions are taken to make the remote conferencees seem stationary even when the local conferencee turns his or her head.

Generally, this virtual steering is accomplished by dynamically modifying each mapped presentation angle based on a current head orientation of the local conferencee in order to make it seem to the local conferencee as if the perceived location of the voice of each of the remote site conferencees within the local site sound-field does not change whenever the local conferencee changes head orientation. More particularly, the head orientation of the remote participant is tracked using conventional methods such as visual tracking or using head orientation sensors (which can be a combination of magnetic field and gravity sensors). As will be recalled, the mapping between the capture angles θ and presentation angles φ was based in part on an assumption of a zero angle direction for Φ. This zero angle direction roughly corresponds to the direction the local conferencee would be looking if situated at the remote site in the shaded area shown in FIG. 1 and facing the center of the microphone array. The deviation, plus or minus, from the zero angle direction is derived from the head orientation tracking. This deviation is then factored into the mapping of Eq. (1) as follows:

$$φ ( θ ) = \frac{Φ}{π} ( θ - {θ}_{c} - {θ}_{h} ) - Φ \qquad ( 10 )$$

where θₕ is the head orientation deviation from the zero angle direction.

Accordingly, the mapping changes dynamically based on the local conferencee's head orientation in order to make it seem as if the remote conferencees that are speaking are stationary.

### 2.0 Stereophonic Teleconferencing with Two or More Remote Sites

As indicated previously in connection with the example of FIG. 1, the stereophonic teleconferencing system embodiments described herein can have more than one remote site involved. For example, additional remote sites (such as sites 104/106 in FIG. 1) can be integrated into the teleconference as well. The remote sites can all be sites with multi-conferencees that employ a microphone array (such as sites 102/104 in FIG. 1), or the remote sites can be a mixture of one or more multi-conferencee sites employing a microphone array (such as sites 102/104 in FIG. 1) and single conferencee sites (such as site 106 in FIG. 1) typically employing a single stereo microphone (such as 128 in FIG. 1).

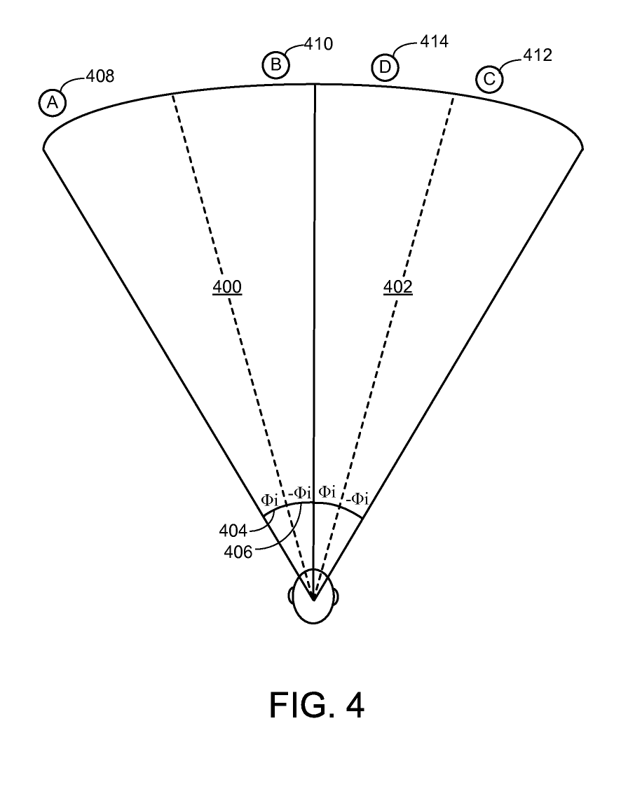

Generally, the multiple remote site scenario can be handled by splitting up the angular space defined by the Φ and −Φ angles into as many sectors as there are remote sites participating in the teleconference. For example, if there were two multi-conferencee remote sites involved in the teleconference, the angular space at the local site can be split into two angular sectors, as shown in FIG. 4. The voices of the conferencees 408/410 at the first remote site can be spatialized as described previously within a first angular sector 400, and the voices of the conferencees 412/414 at the second remote site can be spatialized in the second angular sector 402. Thus, each sector 400/402 would have its own angular space defined by angles Φᵢ 404 and −Φᵢ 406, where i equals the number of the sector.

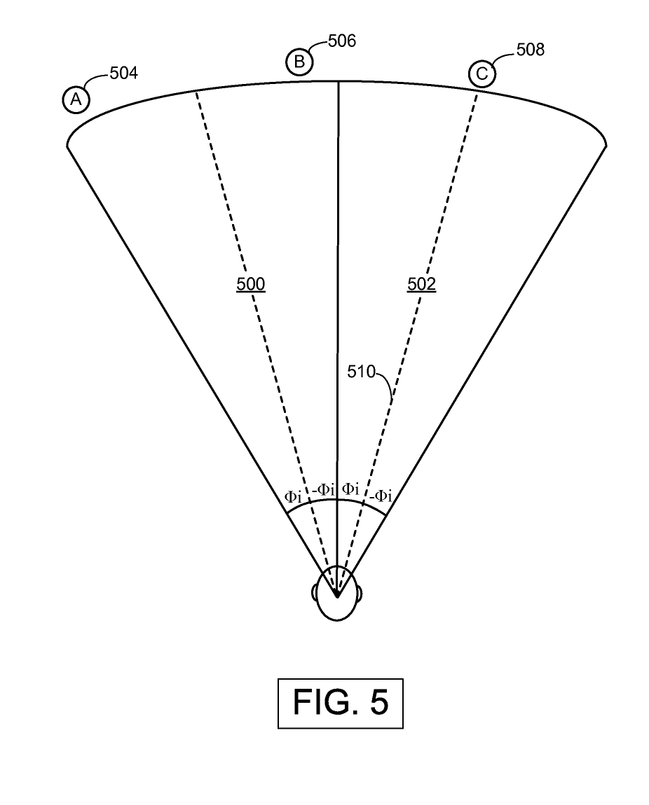

In a case where, in addition to one or more multi-conferencee remote sites being involved in the teleconference, there is at least one single conferencee remote site also participating, the angular space at the local site is split as before between the remote sites. The multi-conferencee remote sites are handled as described previously. Thus, referring to FIG. 5, the voices of the multiple conferencees 504/506 at the first remote site are spatialized as described previously within a first angular sector 500. However, in the case of the sector 502 dedicated to a single conferencee remote site from which a single monophonic audio data stream is provided, the data stream is processed to generate an audio signal for each loudspeaker so as to make it seem that the voice of the remote site conferencee 508 is coming from an arbitrary angle within the sector. Each audio signal is then played through its respective loudspeaker to produce a spatial audio sound-field which is audibly perceived by the local conferencee as having the voice of the single conferencee at the remote site coming from a location within the sub-region of the local conferencee's angular presentation region assigned to the remote site. For example, the voice of the single conferencee 508 from the remote site can be placed at Φᵢ=0 (510), thus putting his or her voice in the middle of the sector 502.

### 3.0 Exemplary Operating Environments

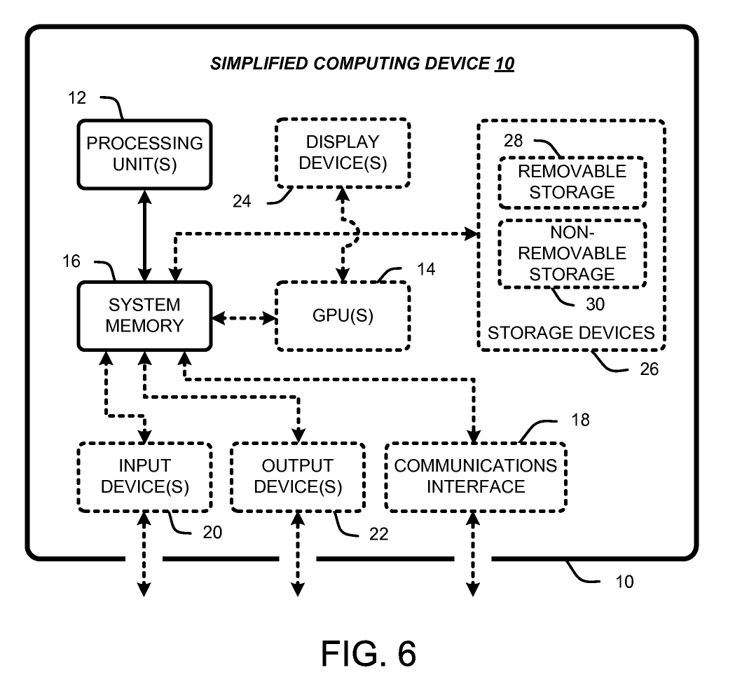

The aforementioned computing devices of the stereophonic teleconferencing system embodiments described herein are operational within numerous types of general purpose or special purpose computing system environments or configurations. FIG. 6 illustrates a simplified example of a general-purpose computer system on which various implementations and elements of the stereophonic teleconferencing system embodiments, as described herein, may be implemented. It should be noted that any boxes that are represented by broken or dashed lines in FIG. 6 represent alternate embodiments of the simplified computing device, and that any or all of these alternate embodiments, as described below, may be used in combination with other alternate embodiments that are described throughout this document.

For example, FIG. 6 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the stereophonic teleconferencing system embodiments described herein, the device should have a sufficient computational capability and system memory to enable basic computational operations. In particular, as illustrated by FIG. 6, the computational capability is generally illustrated by one or more processing unit(s) 12, and may also include one or more GPUs 14, either or both in communication with system memory 16. Note that that the processing unit(s) 12 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 6 may also include other components, such as, for example, a communications interface 18. The simplified computing device of FIG. 6 may also include one or more conventional computer input devices 20 (e.g., pointing devices, keyboards, audio input devices, video input devices, haptic input devices, devices for receiving wired or wireless data transmissions, etc.). The simplified computing device of FIG. 6 may also include other optional components, such as, for example, one or more conventional display device(s) 24 and other computer output devices 22 (e.g., audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 6 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the stereophonic teleconferencing system embodiments described herein, or portions thereof, may be stored, received, transmitted, or read from any desired combination of computer or machine readable media or storage devices and communication media in the form of computer executable instructions or other data structures.

Finally, the computer program of the stereophonic teleconferencing system embodiments described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

### 4.0 Other Embodiments

While an assumption is made in the foregoing descriptions of the stereophonic teleconferencing system embodiments that the local site conferencee's virtual listening position in a multi-conferencee remote site is at the edge a conference table, it is noted that this does not need to be the case. Generally, this virtual listening position can be anywhere along the shaded area shown in FIG. 1. However, if the virtual listening position results in one of more of the remote site conferencees being behind the local conferencee, the ±Φ angle range increases beyond ±90 degrees, and if a stand-alone loudspeaker configuration is being employed at the remote site, there will have to be at least a pair of speakers behind the local conferencee at the local site.

It is further noted that there could be more than one local conferencee at the local site. In such a case, the foregoing stereophonic teleconferencing system embodiment would produce a sound-field at the local site that is perceived to an extent in the same way by each of the local conferencees. When multiple local conferencees are wearing headphones or earphones, the foregoing procedures are duplicated for each local conferencee and the audio experience is substantially identical. When stand-alone loudspeakers are employed at the local site, the foregoing procedures need not be duplicated but the audio experience is slightly different for each local conferencee based on their relative locations within the local site.

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A stereophonic teleconferencing system for spatializing audio for a local conferencee at a local site who is participating in a teleconference with a site remote from the local site which comprises a plurality of co-situated conferencees, comprising:
an audio output device comprising a plurality of loudspeakers;
a general purpose computing device which is in communication with a computer network; and
a computer program comprising program modules executable by the computing device, wherein the computing device is directed by the program modules of the computer program to,
receive a plurality of monophonic audio data streams from the remote site over the computer network, wherein each of the monophonic audio data streams received from the remote site corresponds to the output of a different microphone in a microphone array resident at the remote site,
process the plurality of monophonic audio data streams received from the remote site to generate an audio signal for each loudspeaker, and
play each generated audio signal through its respective loudspeaker to produce a spatial audio sound-field which is audibly perceived by the local conferencee as having the voice of each of the plurality of co-situated conferencees at the remote site coming from a different location within the sound-field.

2. The stereophonic teleconferencing system of claim 1, wherein the remote site microphone array resides at a location that is substantially surrounded by the plurality of co-situated conferencees at that site, and wherein each of the received monophonic audio data streams represents sound captured from sound sources located in an angular sector facing outwardly from prescribed center point of the array, and wherein each angular sector is assigned a capture angle representing an angle from a prescribed arbitrary zero angle line to a line bisecting the angular sector, and wherein the program module for processing the plurality of monophonic audio data streams received from the remote site to generate an audio signal for each loudspeaker, comprises sub-modules for:
defining a local conferencee sound-field comprising an angular presentation region sweeping outwardly from the local conferencee's face;
receiving the capture angle assigned to the angular sector associated with each of the received monophonic audio data streams from the remote site over the computer network;
for each received monophonic audio data stream, mapping the capture angle assigned to the angular sector associated with the stream to a different presentation angle within the local conferencee's angular presentation region using a prescribed mapping scheme; and
generating an audio signal for each loudspeaker from the received monophonic audio data stream which when played produce a spatial audio sound-field which is audibly perceived by the local conferencee as having the voice of each of the plurality of co-situated conferencees at the remote site coming from a different location within local conferencee's angular presentation region.

3. The stereophonic teleconferencing system of claim 2, wherein the angular presentation region is bisected by a zero presentation angle line, bounded to the right of the zero presentation angle line by a maximum positive presentation angle and on the left of the zero presentation angle line by a maximum negative presentation angle, and wherein the sub-module for mapping the capture angle assigned to the angular sector associated with a stream to a different presentation angle within the local conferencee's angular presentation region, comprises mapping capture angles less than a prescribed cutting angle to a portion of the angular presentation region to the left of the zero presentation angle line and capture angles exceeding the prescribed cutting angle to a portion of the angular presentation region to the right of the zero presentation angle line.

4. The stereophonic teleconferencing system of claim 3, wherein the prescribed cutting angle is chosen to be in between the capture angles associated with a pair of adjacent monophonic audio data streams exhibiting the least normalized correlation, wherein a pair of monophonic audio data streams is adjacent to each other if no other monophonic audio data stream has a capture angle between the capture angles of the pair of monophonic audio data streams.

5. The stereophonic teleconferencing system of claim 3, wherein the computer program further comprises a program module for receiving a video feed from the remote site over the computer network, and wherein the prescribed cutting angle is chosen such that a substantially horizontal line projecting out from the center point of the remote site's microphone array at the chosen angle comes no closer than a prescribed offset distance from any of the remote site's plurality of co-situated conferencees as determined using the video feed from the remote site.

6. The stereophonic teleconferencing system of claim 3, wherein the computer program further comprises a program module for receiving a video feed from the remote site over the computer network which reveals the remote site has a display screen, and wherein the prescribed cutting angle is chosen such that a substantially horizontal line projecting out from the center point of the remote site's microphone array at the chosen angle is directed perpendicular to the display screen using the video feed from the remote site.

7. The stereophonic teleconferencing system of claim 3, wherein the maximum positive presentation angle is 90 degrees and the maximum negative presentation angle is −90 degrees.

8. The stereophonic teleconferencing system of claim 3, wherein the maximum positive presentation angle is 180 degrees and the maximum negative presentation angle is −180 degrees.

9. The stereophonic teleconferencing system of claim 2, wherein collectively the received monophonic audio data streams represent sound captured in a 360 degree area around the remote site's microphone array.

10. The stereophonic teleconferencing system of claim 2, wherein the audio output device comprises stereo headphones or earphones comprising a pair of integrated loudspeakers which are disposed onto or in the ears of the local conferencee.

11. The stereophonic teleconferencing system of claim 10, wherein the sub-program for mapping the capture angle associated with each of the received monophonic audio data streams to a different presentation angle within the local conferencee's angular presentation region, further comprises dynamically modifying each mapped presentation angle based on a current head orientation of the local conferencee in order to make it seem to the local conferencee as if the perceived location of the voice of each of the remote site conferencees within the local site sound-field does not change whenever the local conferencee changes head orientation.

12. The stereophonic teleconferencing system of claim 2, wherein the audio output device comprises a set of stand-alone loudspeakers, a first of which is positioned in the local site so as to face the local conferencee from a location corresponding to a first outer edge of the angular presentation region, and a second of which is positioned in the local site so as to face the local conferencee from a location corresponding to a second outer edge of the angular presentation region, and wherein any additional stand alone loudspeakers are positioned in the local site so as to face the local conferencee from a location between the first and second outer edges of the angular presentation region.

13. The stereophonic teleconferencing system of claim 2, wherein the sub-module for mapping the capture angle assigned to the angular sector associated with each monophonic audio data stream to a different presentation angle within the local conferencee's angular presentation region, further comprises periodically:
varying the capture angle assigned to the angular sector associated with one or more of the monophonic audio data streams; and
re-mapping the varied capture angle assigned to the angular sector associated with each monophonic audio data stream whose capture angle was varied to a different presentation angle within the local conferencee's angular presentation region to make it seem to the local site conferencee as if a conferencee whose voice was captured in the angular sector is moving.

14. A stereophonic teleconferencing system for spatializing audio for a local conferencee at a local site who is participating in a teleconference with two or more sites each of which is remote from the local site and at least one of which comprises a plurality of co-situated conferencees, comprising:
an audio output device comprising a plurality of loudspeakers;
a general purpose computing device which is in communication with a computer network; and
a computer program comprising program modules executable by the computing device, wherein the computing device is directed by the program modules of the computer program to,
for each remote site comprising a plurality of co-situated conferencees,
receive a plurality of monophonic audio data streams from the remote site over the computer network, wherein each of the monophonic audio data streams received from the remote site corresponds to the output of a different microphone in a microphone array resident at the remote site,
process the plurality of monophonic audio data streams received from the remote site to generate an audio signal for each loudspeaker, and
play each generated audio signal through its respective loudspeaker to produce a spatial audio sound-field which is audibly perceived by the local conferencee as having the voice of each of the plurality of co-situated conferencees at the remote site coming from a different location within the sound-field.

15. The stereophonic teleconferencing system of claim 14, wherein for each remote site comprising a plurality of co-situated conferencees, the remote site microphone array resides at a location that is substantially surrounded by the plurality of co-situated conferencees at that site, and wherein each of the received monophonic audio data streams represents sound captured from sound sources located in an angular sector facing outwardly from prescribed center point of the array, and wherein each angular sector is assigned a capture angle representing an angle from a prescribed arbitrary zero angle line to a line bisecting the angular sector, and wherein the program module for processing the plurality of monophonic audio data streams received from the remote site to generate an audio signal for each loudspeaker, comprises sub-modules for:
defining a local conferencee sound-field at the local site comprising an angular presentation region sweeping outwardly from the local conferencee's face, wherein the angular presentation region is divided into separate sub-regions each of which is assigned to a different one of the two or more remote sites;
receiving, over the computer network, the capture angle assigned to the angular sector associated with each of the monophonic audio data streams received from each remote site comprising a plurality of co-situated conferencees; and
for each received monophonic audio data stream from each remote site comprising a plurality of co-situated conferencees,
mapping the capture angle assigned to the angular sector associated with the stream to a different presentation angle within the sub-region of the local conferencee's angular presentation region assigned to the remote site associated with the stream using a prescribed mapping scheme, and
generating an audio signal for each loudspeaker from the received monophonic audio data stream such that when played produce a spatial audio sound-field which is audibly perceived by the local conferencee as having the voice of each of the plurality of co-situated conferencees at the remote site coming from a different location within the sub-region of the local conferencee's angular presentation region assigned to the remote site associated with the stream.

16. The stereophonic teleconferencing system of claim 14, wherein at least one of the two or more remote sites has a single conferencee, and wherein the computer program further comprising program modules for:
defining a local conferencee sound-field at the local site comprising an angular presentation region sweeping outwardly from the local conferencee's face, wherein the angular presentation region is divided into separate sub-regions each of which is assigned to a different one of the two or more remote sites; and
for each remote site having a single conferencee,
receiving a monophonic audio data stream from the remote site over the computer network,
processing the monophonic audio data stream received from the remote site to generate an audio signal for each loudspeaker, and
playing each generated audio signal through its respective loudspeaker to produce a spatial audio sound-field which is audibly perceived by the local conferencee as having the voice of the conferencee at the remote site coming from a location within the sub-region of the local conferencee's angular presentation region assigned to the remote site.

17. A stereophonic teleconferencing system for providing a plurality of monophonic audio data streams from a remote site which has a plurality of co-situated conferencees to a local site having a local conferencee who is participating in a teleconference with the remote site, comprising:
a microphone array resident at the remote site comprising a plurality of microphones;
a general purpose computing device at the remote site which is in communication with a computer network; and
a computer program comprising program modules executable by the computing device, wherein the computing device is directed by the program modules of the computer program to send the plurality of monophonic audio data streams from the remote site to the local site over the computer network, wherein each of the monophonic audio data streams corresponds to the output of a different microphone in the microphone array.

18. The stereophonic teleconferencing system of claim 17, wherein the microphone array resides at a location within the remote site that is substantially surrounded by the plurality of co-situated conferencees at that site, and wherein each of the monophonic audio data streams represents sound captured from sound sources located in an angular sector facing outwardly from a prescribed center point of the array, and wherein each angular sector is assigned a capture angle representing an angle from a prescribed arbitrary zero angle line to a line bisecting the angular sector, and wherein the computer program further comprises a program module for sending the capture angle assigned to the angular sector associated with each of the monophonic audio data streams from the remote site to the local site over the computer network.

19. The stereophonic teleconferencing system of claim 18, wherein the microphone array is a directional circular microphone array.

20. The stereophonic teleconferencing system of claim 18, wherein the microphone array is one of an omni-directional circular microphone array or a linear microphone array, and wherein the signal output from each microphone in either type of array is simultaneously subjected to a beamforming procedure each of which produces a monophonic audio data stream representing sound captured from sound sources located in a different angular sector facing outwardly from a prescribed center point of the array.
